(19) United States
(12) Patent Application Publication
(10) Pub. No.: US 2005/0199315 A1
(43) Pub. Date: Sep. 15, 2005

(54) Tank closure

(76) Inventor: Konrad H. Scharrer, Hilden (DE)

Correspondence Address: BERENATO, WHITE & STAVISH, LLC, 6550 ROCK SPRING DRIVE, SUITE 240, BETHESDA, MD, 20817, US

(21) Appl. No.: 11/074,752

(22) Filed: Mar. 9, 2005

(30) Foreign Application Priority Data
Mar. 9, 2004 (DE) 10 2004 011753.5-

(51) Int. Cl. E05C 5/00

(52) U.S. Cl. 141/350; 220/DIG. 3

(57) ABSTRACT

A tank closure comprises first and second closure members which, as a result of the insertion of a fueling nozzle, are movable between a closed position and an open position. A bypass has a venting valve that is connected to the first closure member so that upon motion of the first closure member out of its closed position toward an open position, the venting valve is likewise moved out of a closed position into an open position, and vice versa. A stop device comprises a movable stop element operationally connected to the first closure member and/or to the venting valve. Opening of the second closure member causes the stop element to travel into the motion region of the second closure member. With the closing motion of the first closure member, the stop element travels back into the initial position.

### CROSS-REFERENCE TO RELATED APPLICATIONS AND CLAIM TO PRIORITY

This application claims priority to patent application number 10 2004 011753.5-25, filed Mar. 9, 2004 in the Federal Republic of Germany, the disclosure of which is incorporated herein by reference.

### FIELD OF THE INVENTION

The invention concerns a tank closure for a tank neck that comprises a first and a second closure member one behind another which, as a result of the insertion of a fueling nozzle, are movable against the action of a return device out of a closed position into an open position, there being provided parallel to the second closure member a bypass having arranged therein a venting valve that is connected to the first closure member in such a way that upon motion of the first closure member out of its closed position toward its open position, the venting valve is likewise moved out of a closed position into an open position, and vice versa.

### BACKGROUND OF THE INVENTION

Tank necks that are equipped with a tank closure in which a first and a second closure member are arranged one behind another are known in the existing art, the closure members as a rule being embodied as dish-shaped, pivotably suspended closure flaps (see WO 00/54999; U.S. Pat. No. 6,009,920 A). A bypass having a venting valve arranged therein is provided parallel to the second closure member. The venting valve is kinematically connected to a lever protruding into the tank neck before the second closure flap in the filling direction. Insertion of the fueling nozzle causes the lever to pivot, with the result that the venting valve is opened before the fueling nozzle reaches the second closure member. A pressure equalization between the fuel tank and the atmosphere thus occurs, with the result that when the second closure member is pushed against, a substantial pressure difference no longer exists there, thus preventing any fuel present on the closure flap from being sprayed out.

In a further development of the tank closure described above, the closure members are arranged so that as a result of insertion of the fueling nozzle, both of them are movable against the action of a return device out of their closed position into their open position (see WO 03/086805 A1; EP 1 329 353 A1). The first closure member is connected to the venting valve in such a way that upon motion of the first closure member out of its closed position toward its open position, the venting valve is likewise moved out of a closed position into an open position, and vice versa. In addition, the first closure member is kinematically connected to the second closure member in such a way that upon insertion of the fueling nozzle, and thus upon opening of the first closure member, the second closure member is simultaneously also opened. Conversely, upon withdrawal of the fueling nozzle the second closure member remains open until the fueling nozzle has been withdrawn past the first closure member. In this fashion, any residual fuel that continues to run out of the fueling nozzle will still flow into the tank, i.e. it does not collect on the second closure member.

A disadvantage of this design is that the linkage for connecting the first closure member to the venting valve and for connecting the latter to the second closure member is very sensitive in terms of adjustment and wear. The linkage must be aligned so that in the closed position, both closure members and the venting valve are also in fact closed. Considerable manufacturing and adjustment difficulties are encountered in meeting this requirement.

### SUMMARY OF THE INVENTION

It is thus the object of the invention to configure a tank closure of the kind cited initially on the one hand so as to ensure that in the closed position, both closure flaps and the venting valve are closed, but on the other hand so that fuel continuing to flow out of the fueling nozzle can run off into the tank.

This object is achieved, according to the present invention, in that a stop device is provided which comprises a movable stop element that is operationally connected to the first closure member and/or to the venting valve in such a way that after opening of the second closure member, the stop element travels out of an initial position into the motion region of the second closure member in such a way that upon motion of the second closure member in the closing direction, complete closing of the latter is prevented; and that with the closing motion of the first closure member, the stop element travels back into the initial position.

The basic idea of the invention is thus to provide a stop device that prevents the second closure member from closing completely when the fueling nozzle is withdrawn from the tank closure. Any fuel that continues to flow out of the fueling nozzle can then flow past the second closure member into the tank as long as the stop element is preventing complete closing of the second closure member. It is only with the closing of the first closure member that the stop element is moved out of the motion region of the second closure member, so that the second closure member can then also close. Provision of the stop device means that a direct kinematic connection between the first and the second closure member is no longer necessary. The possibility instead exists of retaining the second closure member in movable fashion independently of the first closure member. The disadvantages, set forth above, of a direct kinematic connection between the first and the second closure member are thus avoided.

In an embodiment of the invention, provision is made for the second closure member to be arranged in such a way that it is movable out of its closed position into the open position upon insertion of the fueling nozzle, as a result of the latter's direct impingement. This does not exclude the possibility that the motion of the second closure member can also occur by means of a lever protruding into the tank neck and kinematically connected to the second closure member, as is known from WO 00/54999 or U.S. Pat. No. 6,009,920 A.

The stop element as such can have any desired configuration, provided it performs its function as described above. For example, the stop element can comprise at least one stop arm whose free end is movable into the motion region of the second closure member. Instead of only one stop arm, two stop arms can also be provided by configuring the stop element in a fork shape. The two stop arms are then movable into the motion region of the second closure member. Advantageously, they are guided movably in the plane of the second closure member. For that purpose, the stop arms can be embodied flexibly and guided in gated fashion in such a way that they are bent upon movement out of their initial position into the motion region of the second closure member.

According to a further feature of the invention, provision is made for the stop element to be kinematically connected to the venting valve. This can be done in such a way that the venting valve comprises a valve stem that is connected to the stop element and kinematically connected to the first closure member. The valve stem can extend perpendicularly to the planes of the closure members in their closed positions. A particularly useful embodiment results if the stop elements and valve stem are connected to one another in such a way that a motion of the valve stem in the opening direction causes a displacement of the stop element in the plane of the second closure member in its closed position, and vice versa.

The connection between the stop element and valve stem can be provided in such a way that the stop element and valve stem are connected via reciprocal sliding elements, the sliding element on the stop-element side conformingly surrounding the valve stem, and the valve stem comprising a curvature that effects a displacement of the stop element upon motion of the valve stem. The stop element should be spring-loaded in the direction of its initial position.

### BRIEF DESCRIPTION OF THE DRAWINGS

The invention is elucidated in more detail, with reference to an exemplifying embodiment, in the drawings, in which:

FIG. 1 is a vertical section in plane A-A of FIG. 3 through a tank closure;

FIG. 2 is a vertical section in plane B-B of FIG. 3 through the tank closure shown in FIG. 1;

FIG. 3 is a view from below of the tank closure according to FIGS. 1 and 2 in the closed position;

FIG. 4 is a vertical section in plane C-C of FIG. 2 through the tank closure according to FIGS. 1 through 3;

FIG. 5 is a cross section in plane D-D of FIG. 1 through the tank closure according to FIGS. 1 through 4;

FIG. 6 is a view from below of the tank closure according to FIGS. 1 through 5, the first and second closure flaps being in the open position;

FIG. 7 is a vertical section in plane A-A of FIG. 3 through the tank closure according to FIGS. 1 through 6, with a fueling nozzle completely inserted; and FIG. 8 is a vertical section through the tank closure according to FIGS. 1 through 7 as depicted in FIG. 7, with the fueling nozzle partially withdrawn.

### DETAILED DESCRIPTION OF THE PREFERRED EMBODIMENT(S)

Tank closure 1 depicted in the Figures comprises a sheath-shaped outer housing 2 made of sheet steel which is open at the bottom and top ends and into which is inserted, from below, an insert 3 made of plastic. Insert 3 comprises an inner part 4 and an annular part 5 that surrounds inner part 4 in the lower region and is pressed with frictional engagement into outer housing 2. Inner part 4 and annular part 5 are immovably connected to one another via bayonet flanges. Tank closure 1 is intended to be placed with its lower end onto the exposed end of a tank neck (not depicted here), and then constitutes the closure end of the tank neck.

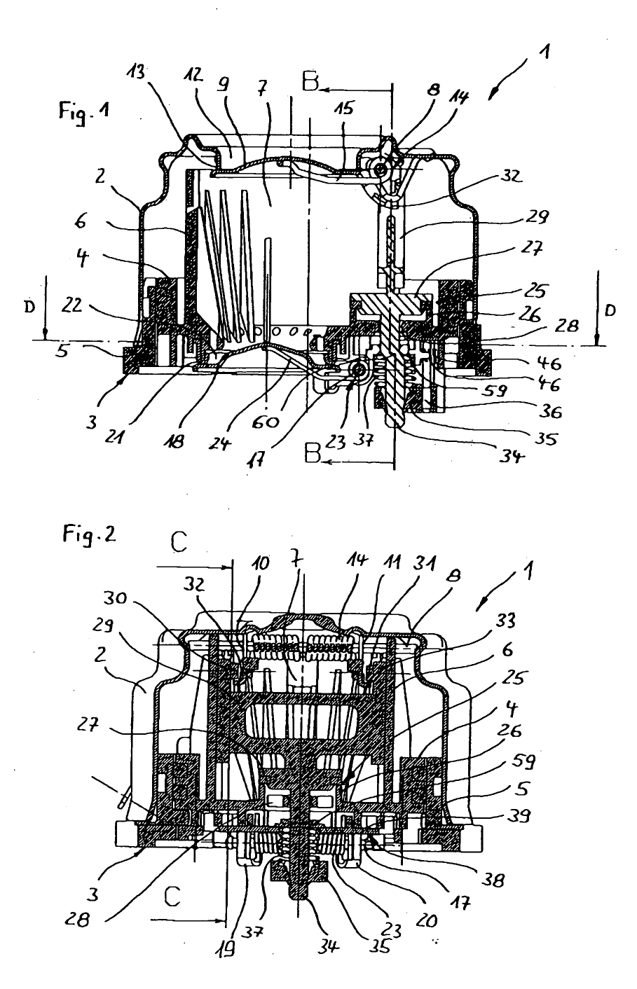

Inner part 4 comprises an inner part wall 6, U-shaped in cross section, that is elevated substantially vertically and encloses a flowthrough conduit 7. In the upper region, as is evident in particular in FIG. 2, the open side of inner conduit wall 7 is spanned by a horizontal first flap shaft 8. A dish-shaped first closure flap 9 is pivotably mounted via mounting struts 10, 11 on first flap shaft 8. In the closed position (FIGS. 1 through 4), first closure flap 9 covers an insertion opening 12 on the upper side of outer housing 2 by the fact that first closure flap 9 is in contact from the inside against an rim flange 13 of insertion opening 12.

Between mounting struts 10, 11, first flap shaft 8 is surrounded by the helical turns of a spring 14. At the center, spring 14 constitutes a spring arm 15 that extends as far as the center of first closure flap 9 and is in contact against its inner side. Spring 14 is braced in such a way against inner part wall 6, and tensioned in such a way, that spring arm 15 presses first closure flap 9 against rim flange 13 with a predetermined force.

Parallel to first flap shaft 8 and only slightly horizontally offset with respect thereto, a second flap shaft 17 is arranged and secured in the lower region of inner part 4. A second closure flap 18 is pivotably mounted on this second flap shaft 17 via mounting struts 19, 20. Second closure flap 18 is also dish-shaped, and in the closed position (FIGS. 1 through 4) is in contact from below against a rim flange 21 that surrounds a second insertion opening 22 in the lower region of inner part 4. In the same manner as with first closure flap 9, second flap shaft 17 is surrounded by the turns of a spring 23 that constitutes at the center a spring arm 24 which is in contact against the underside of second closure flap 18. This spring 23 is also braced against inner part 4, and is tensioned so that in the closed position, it presses second closure flap 18 against rim flange 21 with a predetermined force.

A venting valve 25 is arranged in the region of the open side of inner part wall 6. Venting valve 25 has, in the lower region of inner part 4, an annular valve seat 26 against which, in the closed position, a valve head 27 is in sealing contact from above. Valve seat 26 is penetrated by a bypass opening 28 that, in the open position of venting valve 25, creates a connection between flowthrough conduit 7 and the tank neck contiguous with tank closure 1, and thus the tank.

Shaped onto the upper side of valve head 27 is a guidance slide 29 that is guided vertically displaceably on the inner sides of inner part wall 6. In the upper region, guidance slide 29 comprises two projections 30, 31, directed toward one another, under which are fitted actuation struts 32, 33. Actuation struts 32, 33 are rigidly connected to mounting struts' 10, 11 and consequently to first closure flap 9, and are shaped so that upon a pivoting of first closure flap 9 toward its open position, i.e. inward, they upwardly entrain projections 30, 31 and therefore also guidance slide 29 having valve head 27, i.e. displace them vertically upward. In this fashion, valve head 27 lifts off from valve seat 26 and thus opens venting valve 25. The result of this, in turn, is that through bypass opening 28 a pressure equalization is achieved, between the tank on the one hand and the external atmosphere on the other hand, when a fueling nozzle is inserted into flowthrough conduit 7 by pivoting first closure flap 9, specifically before the free end of the fueling nozzle reaches second closure flap 18.

A guide rod 34 is shaped onto the underside of valve head 27. In the region of its exposed lower end, guide rod 34 is surrounded by a guide ring 35 that once again constitutes a slide which is guided vertically displaceably on a slide guide 36 that is shaped on the underside of inner part 4. Slide guide 36 and guide ring 35, together with guidance slide 29, ensure exact vertical guidance of valve head 27. Guide ring 35 sits on the enlarged end of guide rod 34 that extends downward beyond guide ring 35.

Guide rod 34 is surrounded by a helical spring 37 that is braced at the bottom end on guide ring 35 and at the top end against a plate-shaped stop device 38 that in turn is braced against the underside of inner part 4. Because helical spring 37 is loaded in compression, it endeavors to push valve head 27 onto valve seat 26, i.e. upon liftoff of valve head 27 from valve seat 26, guide ring 35 is entrained upward via guide rod 34 and thereby compresses helical spring 37. Liftoff is possible even when first closure flap 9 is closed, and is brought about automatically when a corresponding overpressure forms in the tank and acts on valve heat 27.

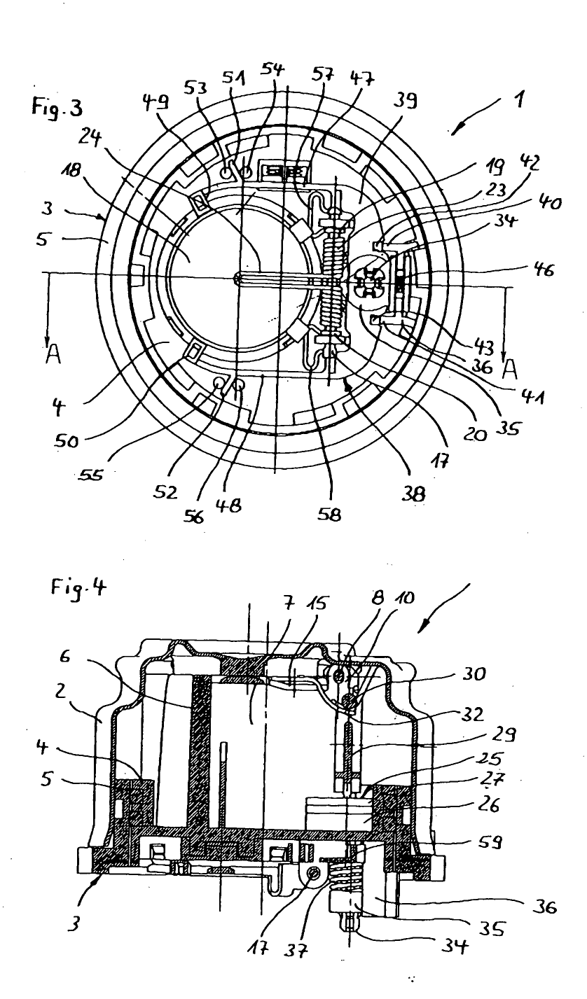

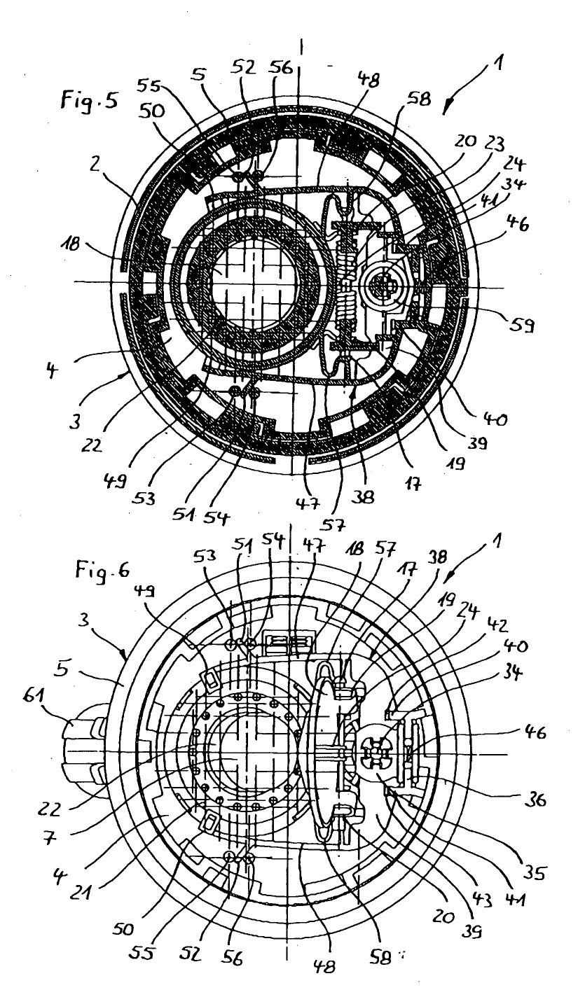

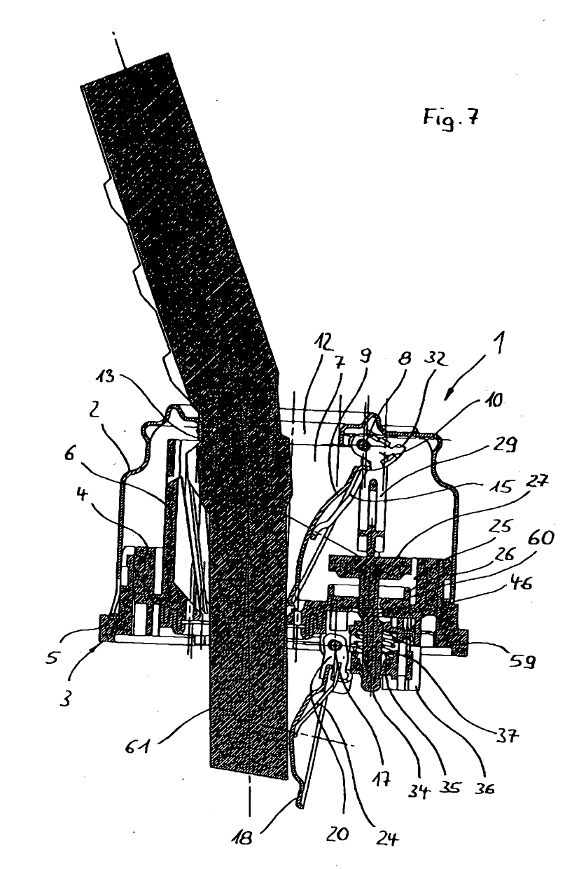

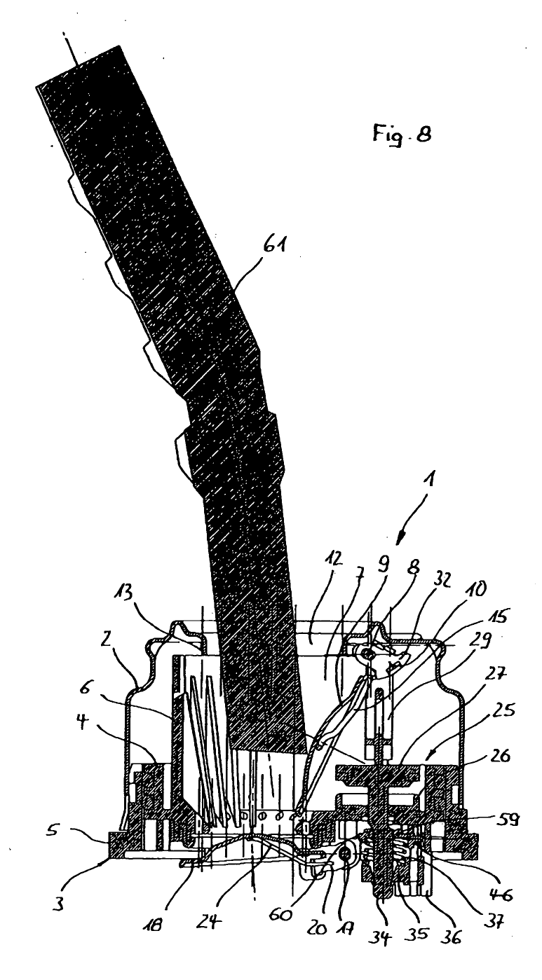

As is evident in particular from FIGS. 2 and 3 as well as 5 and 6, stop device 38 comprises a base plate 39 that is pressed from below by helical spring 37 against flanges shaped onto the underside of inner part 4. As is evident in particular from FIGS. 5 and 6, base plate 39 fits with guide slots 42, 43 into projecting guide flanges 44, 45 of slide guide 36. In this fashion, base plate 39 and thus stop device 38 are displaceably guided horizontally, i.e. in a plane parallel to the plane of second insertion opening 22 and toward the center point of insertion opening 22. Stop device 38 is preloaded in this direction by a horizontal spring 46.

Proceeding from the side ends of base plate 39 are elastically resilient stop arms 47, 48 that extend on either side of second insertion opening 22 and have inwardly directed stops 49, 50 at their free ends. Stop arms 47, 48 have outwardly projecting guide flanges 51, 52, which are each enclosed between two guide cylinders 53, 54 and 55, 56 which project from inner part 4 and which form respective gate guides for guide flanges 51, 52. Shaped onto stop arms 47, 48 in the region of base plate 39 are spring elements 57, 58 extending in meander fashion, which endeavor to bend the respective stop arms 47, 48 outward.

Provided in the center of base plate 39 and joined immovably to it is a guide ring 59 which closely surrounds guide rod 34 and against which helical spring 37 is in contact. Guide rod 40 has an offset 60 outward from the vertical, transversely to second insertion opening 22. In the closed position of venting valve 25, guide ring 59 surrounds guide rod 34 directly above offset 60, i.e. between bypass opening 28 and offset 60. As a result, stop device 38 assumes a position in which stops 49, 50 are located outside the motion region of second closure plate 18.

Upon insertion of a fueling nozzle, the above-described tank closure 1 functions as follows:

Insertion of the fueling nozzle, labeled 61 in FIGS. 6 through 8, occurs through first insertion opening 12. As a result of direct impingement by the free end of fueling nozzle 61, first closure flap 9 is pivoted inward against the action of spring 14. In that context, projections 30, 31, and therefore guidance slide 29 and valve head 27, are raised, so that any overpressure (if it has not yet been equalized through venting valve 25) is discharged via bypass opening 28, i.e. the tank acquires a connection to the external atmosphere.

With the raising of valve head 27, guide rod 34 is also raised. Offset 60 slides through guide ring 59 ore base plate 39 and thereby causes a displacement of stop device 38 in a direction radially away from second insertion opening 22 against the action of horizontal spring 46, stop arms 47, 48 also being correspondingly offset in their respective longitudinal directions. Because of the conformation of guide flanges 51, 52, the consequence of this is that in the region of guide flanges 51, 52, stop arms 47, 48 are deflected toward second closure flap 18, as shown by a comparison between FIGS. 3 and 5. As a result, stops 49, 50 are pressed with a preload against the outer rim of second closure flap 18.

In the depiction of FIG. 5, second closure flap 18 is still in the closed position, i.e. the free end of fueling nozzle 61 (not visible here) is still located in flowthrough conduit 7 between the two closure flaps 9, 18. FIGS. 6 and 7 show the situation after complete insertion of fueling nozzle 61; only the externally extending portion of fueling nozzle 61 is visible in FIG. 6, while the portion located in passthrough conduit 7 is omitted. As is evident in particular from FIG. 7, fueling nozzle 61 has also pivoted second closure flap 18 downward against the action of spring 23, so that second insertion opening 22 is also open. The result of the pivoting of second closure flap 18 is that stops 49, 50 pivot inward into the motion region of second closure flap 18, as is apparent from FIG. 6 as compared with FIG. 5.

FIG. 7 also shows the above-described open position of venting valve 25 resulting from the pivoting of first closure flap 8. The raising of valve head 27 is combined with the raising of offset 60, so that guide ring 59 of base plate 39 now surrounds guide rod 34 below offset 60; with the result that guide ring 59, and therefore the entire stop device 38, has been displaced outward around offset 60.

In the position shown in FIG. 7, filling of the tank through fueling nozzle 61 is occurring. After the filling operation, fueling nozzle 61 is withdrawn again from tank closure 1. FIG. 8 shows the position of fueling nozzle 61 in an intermediate position after withdrawal from second insertion opening 22, the free end still being located in flowthrough conduit 7. Because first closure flap 9 is still being held in the inward-pivoted position by fueling nozzle 61, venting valve 25 is also still open, i.e. valve head 27 is still in its state lifted away from valve seat 26, and guide ring 59 also still surrounds guide rod 34 below offset 60. Second closure flap 18 is released, and therefore pivots back in response to spring 23. It is prevented from moving into its closed position, however, by stops 49, 50 (not visible in FIG. 8; see FIG. 6) that were previously pivoted into its motion region. This means that second insertion opening 22 is still open. Any fuel still continuing to flow out of fueling nozzle 61 can therefore flow past second closure flap 18 into the tank.

When fueling nozzle 61 is withdrawn completely, i.e. also out of first insertion opening 12, first closure flap 9 pivots in response to spring 14 toward first insertion opening 12, and ultimately comes into contact against rim flange 13. Actuation struts 32, 33 are shaped so that they allow a lowering of guidance slide 29, and thus of valve head 27 onto valve seat 26, only in the last part of the pivoting motion of first closure flap 9. The lowering of valve head 27 also causes guide rod 34 to be lowered under the action of helical spring 37, with the result that offset 60 slides through guide ring 59 and displaces it back toward second insertion opening 22. Base plate 39 and stop arms 47, 48 are displaced correspondingly. Because of the oblique position of guide flanges 51, 52, the result of this is that stop arms 47, 48 are pivoted back into the initial position shown in FIG. 3, and stops 49, 50 are thus also pivoted outward out of the motion region of second closure flap 18. Second closure flap 18 is thereby released, and in response to spring 23 therefore comes into contact against rim flange 21. All the parts of tank closure 1 have therefore once again reached the initial position depicted in FIGS. 1 through 4.

1. A tank closure (1) comprising a first and a second closure member (9, 18) which, as a result of the insertion of a fueling nozzle (61), are movable against the action of a return device (14, 23) out of a closed position into an open position, there being provided parallel to the second closure member (18) a bypass (28) having arranged therein a venting valve (25) that is connected to the first closure member (9) in such a way that upon motion of the first closure member (9) out of its closed position toward an open position, the venting valve (25) is likewise moved out of a closed position into an open position, and vice versa,
wherein a stop device (38) is provided which comprises a movable stop element (47-50) that is operationally connected to the first closure member (9) and/or to the venting valve (25) in such a way that after opening of the second closure member (18), the stop element (47-50) travels out of an initial position into the motion region of the second closure member (18) in such a way that upon motion of the second closure member (18) in the closing direction, complete closing of the latter is prevented; and that with the closing motion of the first closure member (9), the stop element (47-50) travels back into the initial position.

2. The tank closure as defined in claim 1, wherein the second closure member (18) is movable independently of the first closure member.

3. The tank closure as defined in claim 2, wherein the second closure member (18) is arranged in such a way that it is movable out of the closed position into the open position upon insertion of the fuelingnozzle (61), as a result of the latter's direct impingement.

4. The tank closure as defined in claim 1, wherein the stop element comprises at least one stop arm (47-50) whose free end is movable into the motion region of the second closure member (18).

5. The tank closure as defined in claim 4, wherein the stop element is configured in a fork shape having two stop arms (47-50), both of which are movable into the motion region of the second closure member (18).

6. The tank closure as defined in claim 5, wherein the stop arms (47-50) are guided movably in the plane of the second closure member (18).

7. The tank closure as defined in claim 6, wherein the stop arms (47, 48) are embodied flexibly and are guided in gated fashion in such a way that they are bent upon movement out of their initial position into the motion region of the second closure member (18).

8. The tank closure as defined in claim 1, wherein the stop element (47-50) is kinematically connected to the venting valve (25).

9. The tank closure as defined in claim 8, wherein the venting valve comprises a valve stem (34) that is connected to the stop element (47, 50).

10. The tank closure as defined in claim 9, wherein the valve stem (34) is kinematically connected to the first closure member (9).

11. The tank closure as defined in claim 9, wherein the valve stem (34) extends perpendicularly to the planes of the closure members (9, 18) in their closed positions.

12. The tank closure as defined in claim 11, wherein the stop elements (47-50) and valve stem (34) are connected to one another in such a way that a motion of the valve stem (34) in the opening direction causes a displacement of the stop element (47-50) in the plane of the second closure member (18) in its closed position, and vice versa.

13. The tank closure as defined in claim 12, wherein the stop element (47-50) and valve stem (34) are connected via reciprocally sliding elements (59, 60).

14. The tank closure as defined in claim 13, wherein the sliding element (49) on the stop-element side conformingly surrounds the valve stem (34), and the valve stem (34) comprises a curvature (60) that effects a displacement of the stop element (47-50) upon motion of the valve stem (34).

15. The tank closure as defined in claim 1, wherein the stop element (47-50) is spring-loaded in the direction of its initial position.
